(19) United States
(12) Patent Application Publication
(10) Pub. No.: US 2026/0287820 A1
(43) Pub. Date: Sep. 24, 2026

(54) PHOTONIC WAVEGUIDE

(71) Applicant: ORCA Computing Limited, London (GB)

(72) Inventor: Brian MATTIS, Austin, TX (US)

(21) Appl. No.: 19/476,140

(22) PCT Filed: Apr. 18, 2024
(86) PCT No.: PCT/GB2024/051006

§ 371 Date: Oct. 16, 2025

Related U.S. Application Data
(60) Provisional application No. 63/460,159, filed on Apr. 18, 2023.

(51) Int. Cl. G02B 6/132; G02B 6/136

(52) U.S. Cl. CPC G02B 6/132; G02B 6/136

(57) ABSTRACT

A photonic waveguide and methods of manufacture of a photonic waveguide. The photonic waveguide comprises a core material and a cladding material. The photonic waveguide further comprises a transition layer. A material from which the transition layer is formed transitions as a function of distance between a first side of the transition layer at which the transition layer is formed of the core material and a second side of the transition layer at which the transition layer is formed of the cladding material.

### TECHNICAL FIELD

The present disclosure relates to photonic waveguides and methods of manufacture of photonic waveguides. The methods and devices disclosed herein may incorporated in a Photonic Integrated Circuit (PIC).

### BACKGROUND

Photonic integrated circuits (PICs) are devices that integrate multiple optical components on a single chip. A key component which can be include in a PIC is a waveguide, which is used to guide and confine electromagnetic waves through a channel or path to a certain region of space and uses light instead of electricity to process and transmit information. There are several types of waveguides that can be used in PICs including strip waveguides, ridge waveguides and rib waveguides. The choice of a waveguide typically type depends on the specific application and the requirements of the circuit.

In PICs, waveguides are typically made from high refractive index dielectric materials, such as silicon (Si), silicon nitride (Si₃N₄) or polymer materials, and these can be either planar or cylindrical in shape. These materials typically have low absorption losses at optical frequencies and can be fabricated using standard micro-fabrication techniques such as lithography and etching. The design and optimisation of waveguides in PICs are critical for achieving high performance and low optical losses, which can be reduced by carefully selecting a waveguide material and design parameters of the waveguide, such as the width and height of the waveguide core.

Various techniques are involved in manufacturing a waveguide such as lithography, etching, sequential deposition, and cleaning of individual films. The resulting structures formed have clear interfaces between used materials, such as a core (waveguide) material and a cladding material. A cladding material layer (film or films) typically surrounds the waveguide core and has a different refractive index (lower refractive index) than the core material. Due to different refractive indexes between the cladding material and the core material, the light is contained within the waveguide core. The difference in refractive index also helps to confine an optical mode within the core, thus preventing it from spreading out into the surrounding cladding material. A type of cladding material and its properties has significant impact on the waveguide performance such as a confinement mode, optical losses, and sensitivity to external perturbations.

One of the common lithography methods used in the manufacturing of waveguides is photolithography, which is a process that involves patterning (to create a desired pattern or structure on the surface of a waveguide) a photosensitive material (photoresist) on a waveguide substrate using a photo-mask and UV light. This causes a chemical reaction in the exposed areas of the photoresist, which is then developed using a solvent that dissolves the unexposed areas, leaving behind a patterned mask on the waveguide surface. This patterned mask can then be used to selectively deposit or etch material onto the waveguide surface to create the desired waveguide structure.

A deposition process, which may also be referred to as “waveguide deposition fabrication” or “deposition-based waveguide fabrication,” may comprise two main types of deposition techniques, including but not limited to, Chemical Vapour Deposition (CVD) and Physical Vapour Deposition (PVD). In CVD, a gas-phase precursor is introduced into a reactor (e.g., chamber), where it reacts and deposits onto the substrate to form a thin film. In PVD, a solid material is evaporated under vacuum and deposited onto the substrate. The advantage of deposition-based waveguide fabrication is that it allows the creation of complex waveguide structures with high precision and reproducibility.

Etching, typically performed after the deposition of a thin film, is a process used to remove excess material from the surface in order to create a desired waveguide pattern or structure. One common method of etching is Reactive Ion Etching (RIE) and another is wet etching.

A cleaning step may be used in waveguide deposition to remove any contaminants or impurities that may be present on the surface of the waveguide. These contaminants can impact the deposition process, affect the performance of the final device and prevent the production of high-quality and reliable results.

In conventional processes, surface roughness may occur at the interfaces between a waveguide core and their upper, lower, and side claddings. Surface roughness at the interfaces directly interacts with the guided light that leads to photon scattering. This roughness can be caused by a variety of factors, but can usually be attributed to the following basic mechanisms.
Lower interface: This roughness is caused by the surface roughness of the lower cladding material, either from its deposition process or a chemical-mechanical polishing (CMP) process, CMP is a fabrication technique that uses chemical oxidation and mechanical abrasion to remove material, used to help planarize the film.
Upper interface: This roughness is caused by the surface roughness of the waveguide material, either from the deposition process or due to a CMP process used to help planarize the film.
Side (Lateral) interface: This roughness is caused by line-edge-roughness (LER) induced during the photolithography process used to define the waveguide shape and the subsequent etch process used to remove the excess waveguide material from non-waveguide portions of the wafer.

Scattering that arises due to roughness increases the propagation loss of the waveguide, which is usually measured in decibels (dB) per centimetre (cm) or dB per metre (m), which impacts the overall system performance by decreasing the efficiency. Conventionally known processes/methods may include processes for reducing line-edge-roughness (LER) such as photoresist reflow or hydrogen annealing to reflow the waveguide material itself. However, these processes do not address the roughness issues at a fine level or to all waveguide materials,

Therefore, there is an unmet need for improved grading and deposition processes in a PIC waveguide in order to reduce optical scattering and provide improved performance.

It is in this context the present disclosure has been devised

### BRIEF SUMMARY

The present disclosure addresses the drawbacks of the state of the art by providing improved solutions to the techniques or methods of the known state of the art, associated with photonic waveguides. In particular it has been realised that the deposition of one or more transition layers may provide advantageous effects in a manufactured waveguide. A transition layer may be deposited such that a material from which the transition layer is formed varies as a function of distance in the transition layer (or equivalently as a function of time during deposition). In particular, the material composition of a transition layer may vary between a first side of the transition layer, at which the transition layer is formed of a core material, and a second side of the transition layer, at which the transition layer is formed of a cladding material. The transition layer between the first side and second side may comprise an intermediate material comprising a blend of the core material and the cladding material. Such a process may be referred to as a blending of materials from the waveguide core to the cladding. Transition layers as described herein provide a gradual transition between a core material and a cladding material so as to reduce any surface roughness at a core-cladding interface and to reduce optical loss at the interface.

According to a first aspect of the disclosure there is provided a method of manufacture of a photonic waveguide, the waveguide comprising a core material and a cladding material. The method comprises depositing a transition layer. A material from which the transition layer is formed transitions as a function of distance between a first side of the transition layer, at which the transition layer is formed of the core material, and a second side of the transition layer, at which the transition layer is formed of the cladding material.

The transition layer may provide a material transition between the core material and the cladding material. For example, the transition layer may be deposited to provide a gradual transition in material composition between the core and cladding material. This may reduce or avoid discontinuities in material composition at interfaces between the core material and cladding material. As was explained above, an interface between the core material and cladding material in a waveguide may be a source of photon loss, for example, due to photon scattering at the material interface. Such photon scattering may be caused (or at least increased) by surface roughness in a material transition, which may, for example, result from waveguide fabrication techniques such as etching, selective deposition, material deposition and/or surface cleaning or polishing. The transition layer may serve to reduce surface roughness at one or more interfaces between the core material and cladding material and therefore reduce photon scattering sites in the waveguide. Accordingly the transition layer may serve to increase a smoothness of a material transition. One or more of these effects may reduce photon scattering and/or photon loss in the waveguide.

Additionally or alternatively, the deposition of a transition layer may enable reduction of a thermal budget in manufacture of a waveguide. For example, fabrication of one or more components (e.g., in a Photonic Integrated Circuit) may be subject to a thermal budget and/or a temperature limitation to maintain integrity and/or quality of components. For example, the fabrication of silicon photonics with integrated photodetectors and/or modulators may be subject to temperature limitations and/or an overall thermal budget. Existing processes for reducing surface roughness at material transitions may include annealing of materials after deposition. For example, hydrogen annealing may be performed for silicon waveguides and nitrogen or oxygen annealing may be performed for silicon nitrate waveguides. Such annealing processes may involve subjecting components to relatively high temperatures and/or may involve subjecting components to elevated temperatures for relatively long time periods, which may not be compatible with temperature-limited waveguide processes. The deposition of one or more transition layers as disclosed herein may enable smoothing of one or more interfaces between a core material and cladding material with a limited thermal budget and/or may not require subjecting components to high temperatures. For example, the deposition of one or more transition layers may reduce or remove a need to perform an annealing process and thus may enable the manufacture of a low-loss waveguide which is compatible with temperature-limited waveguide processes.

The transition layer may be deposited in the photonic waveguide such that the first side of the transition layer interfaces (contacts) with at least a portion of the core material. The transition layer may be deposited in the photonic waveguide such that the second side of the transition layer interfaces (contacts) with at least a portion of the cladding material.

The transition layer between the first side (at which the transition layer is formed of the core material) and the second side (at which the transition layer is formed of the cladding material) comprises an intermediate material comprising components of the core material and components of the cladding material. The composition of the transition layer varies as a function of distance between the first side and the second side of the transition layer. The composition of the transition layer may vary continuously (i.e., with substantially no discontinuities) between the first side and the second side.

The transition layer may be deposited such that the refractive index of the transition layer varies as a function of distance between the first side (at which the refractive index is that of the core material) and the second side (at which the refractive index is that of the cladding material) of the transition layer. The refractive index of the transition layer may vary as a continuous function of distance between the first side and the second side of the transition layer. That is, the refractive index of the transition layer may not include any substantial discontinuities between the first side and the second side of the transition layer.

The waveguide may be manufactured such that the transition layer is situated between a layer of the core material and a layer of the cladding material. The transition layer may be arranged in the manufactured waveguide such that the first side of the transition layer contacts the layer of core material and the second side of the transition layer contacts the layer of cladding material. In this way the material (and the refractive index) of the waveguide undergoes a transition between the core and the cladding without discontinuities which may be a source of optical loss.

The order in which the transition layer, the core material and the cladding material are deposited and the order in which the transition layer itself is deposited (i.e., whether deposition begins with the first side or the second side of the transition layer) may vary according to the overall arrangement of the waveguide and/or where the transition layer is used in the waveguide structure.

In some examples, the transition layer may be deposited so as to provide a transition between a lower surface of the waveguide core and the cladding. In such examples, a layer of cladding material may be deposited (e.g., on a substrate), followed by deposition of the transition layer and then followed by deposition of the core material. In such examples deposition of the transition layer may begin with deposition of the second side of the transition layer (which comprises the cladding material) and end with deposition of the first side of the transition layer (which comprises the core material). The layer of core material may then be deposited onto the first side of the transition layer (which comprises the core material). In this way the transition layer provides a gradual transition between the cladding material and the lower surface of the waveguide core. An upper surface and/or side surfaces of the waveguide core may not be provided with a transition layer. Alternatively, one or more further (second) transition layer(s) may be deposited to provide a transition between an upper surface and/or side surfaces of the waveguide core and the cladding.

In some examples, the transition layer be deposited so as to provide a transition between one or both of side surfaces of the waveguide core and the cladding. In such examples, a layer of core material may be deposited followed by deposition of the transition layer and then followed by deposition of a layer of cladding material. The layer of core material may (after deposition) be etched (e.g, utilising a photolithography process) to expose side surfaces of the core material. The transition layer may then be deposited after exposure of side surfaces of the core material (e.g., through etching). In such examples deposition of the transition layer may begin with deposition of the first side of the transition layer (which comprises the core material) and end with deposition of the second side of the transition layer (which comprises the cladding material). The transition layer may be deposited on one or both side surfaces of the core and may additionally be deposited on an upper surface of the core material. A layer of cladding material may then be deposited onto the second side of the transition layer (which comprises the cladding material). In this way the transition layer provides a gradual transition between one or more side surfaces and optionally an upper surface of the waveguide core and the cladding. A lower surface of the waveguide core may not be provided with a transition layer. Alternatively, one or more further (second) transition layer(s) may be deposited to provide a transition between a lower surface of the waveguide core and the cladding.

In some examples, the transition layer be deposited so as to provide a transition between an upper surface of the waveguide core and the cladding. In such examples, a layer of core material may be deposited followed by deposition of the transition layer. In such examples deposition of the transition layer may begin with deposition of the first side of the transition layer (which comprises the core material) and end with deposition of the second side of the transition layer (which comprises the cladding material). The layer of core material may be etched before (as described above with reference to providing a transition at side surfaces of the core) or after deposition of the transition layer. Where the layer of core material is etched after deposition of the transition layer, the transition layer may only be deposited on the upper surface of the core (and not the side surfaces). The layer of cladding material may then be deposited onto the second side of the transition layer (which comprises the cladding material). In this way the transition layer provides a gradual transition between the upper surface (and optionally one or more side surfaces) of the waveguide core and the cladding. A lower surface of the waveguide core may not be provided with a transition layer. Alternatively, one or more further (second) transition layer(s) may be deposited to provide a transition between a lower surface of the waveguide core and the cladding.

In some examples, one or more of these arrangements may be combined to provide a transition layer on multiple sides of the core. In some examples, a plurality of transition layers may be deposited. For example, a first transition layer may be deposited to provide a transition between a lower surface of the waveguide core and the cladding. A second transition layer may also be deposited which provides a transition between one or both of an upper surface and one or more side surfaces of the waveguide core and the cladding.

References herein to upper, lower and side surfaces of a waveguide core should be interpreted as being relative to other components of a waveguide structure and/or a device (e.g., an photonic integrated circuit) in which the waveguide is incorporated and should not be interpreted as suggesting any limitation as to the absolute orientation of any components (e.g., in a lab frame). For example, references to upper, lower and side surfaces of a waveguide core will generally denote the positioning of the surfaces relative to a substrate on which a waveguide structure is disposed.

The waveguide may form part of a Photonic Integrated Circuit (PIC).

The core material may comprise silicon nitride (Si₃N₄). The cladding material may comprise silicon dioxide (SiO₂). In such examples, the transition layer may be formed of SiOₓN_{y} where x varies between 0 and 2 as a function of distance between the first side of the transition layer and the second side of the transition layer and y varies between 4 and 0 as a function of distance between the first side of the transition layer and the second side of the transition layer. At the first side of the transition layer x may be equal to 0 and N may be equal to 4 such that the material of the transition layer at the first side is silicon nitride (Si₃N₄). At the second side of the transition layer x may be equal to 2 and y may be equal to 0 such that the material of the transition layer at the second side is silicon dioxide SiO₂.

The core material may comprise silicon (Si). The cladding material may comprise silicon dioxide (SiO₂). In such examples the transition layer may be formed of SiOₓ where x varies between 0 and 2 as a function of distance between the first side of the transition layer and the second side of the transition layer. At the first side of the transition layer x may be equal to 0 such that the material of the transition layer at the first side is silicon (Si). At the second side of the transition layer x may be equal to 2 such that the material of the transition layer at the second side is silicon dioxide SiO₂.

The core material may comprise titanium dioxide (TiO₂). The cladding material may comprise silicon dioxide (SiO₂). In such examples the transition layer may be formed of TiₓO₂ where x varies between 1 and 0 as a function of distance between the first side of the transition layer and the second side of the transition layer. At the first side of the transition layer x may be equal to 1 such that the material of the transition layer at the first side is titanium dioxide (TiO₂). At the second side of the transition layer x may be equal to 0 such that the material of the transition layer at the second side is silicon dioxide SiO₂.

Whilst examples of specific materials have been described herein, the methods described are not limited to the materials which are specifically disclosed. The methods disclosed herein may be applied to any suitable core material and cladding material which can be produced in a deposition process such as the processes described herein.

A transition layer as described herein may be deposited in-situ. The transition of material in the transition layer may achieved through in-situ deposition. A transition layer as described herein may have a thickness of the order of about 45 nanometres (nm), however variations are possible. A transition layer as described herein may have a thickness which is less than about 1000 nm.

Methods described herein may be used to manufacture a waveguide having any suitable shape. For example, methods described herein may be used to manufacture a strip waveguide, a ridge waveguide, and/or a rib waveguide.

Depositing the transition layer may comprise releasing a plurality of different source materials, wherein the source materials are deposited to form the deposited transition layer, and wherein a rate at which at least one of the source materials is released during the deposition of the transition layer is varied with time during the deposition so that the material composition of the transition layer being deposited varies as a function of time during the deposition.

Depositing the transition layer may be performed using a Chemical Vapour Deposition (CVD), a Physical Vapour Deposition (PVD) and/or a Molecular Beam Epitaxy (MBE) deposition. A CVD may include one or more of Low-Pressure CVD (LPCVD), Ultrahigh Vacuum (UHVCVD) and/or Plasma-Enhanced CVD (PECVD). A PVD may include one or more of sputtering and/or evaporative deposition (which may include, for example, electron beam evaporation, thermal evaporation, cathodic arc evaporation, and/or laser evaporation etc.).

Releasing the plurality of source materials may comprise releasing the source materials into a chamber (e.g., a vacuum chamber) in which a component, onto which the transition layer is to be deposited, is positioned. Releasing the plurality of source materials may comprise introducing and/or injecting gaseous source materials. Releasing the plurality of source materials may comprise evaporating, vaporising, sputtering and/or sublimation of the source materials.

The source materials may interact (e.g., react) with each other and/or a surface onto which the transition layer is deposited so as to form solid material forming part of the transition layer.

In some examples, a rate at which one of the plurality of source materials is released during the deposition of the transition layer is varied with time during the deposition. A rate at which another of the plurality of source materials is released during the deposition of the transition layer may be varied with time during the deposition or may be held substantially constant during the deposition. In some examples, rates at which the plurality of source materials are released during the deposition of the transition layer are each varied with time during the deposition.

Varying the rates at which the source materials are released during the deposition of the transition layer with time may comprise varying the rates at which different source materials are released during the deposition differently. For example, the rate at which a first source material is released during deposition may be varied differently to the rate at which a second source material is released during deposition. In some examples, a rate at which a first source material is released during deposition may be increased with time. A rate at which a second source material is released during deposition may be decreased with time.

A rate at which a source material is released during deposition may be varied by varying a rate at which the source material is injected (e.g., into a chamber), evaporated, vaporised, sputtered and/or sublimed. For example, a flow rate of a gaseous source material may be varied with time to vary a rate at which the source material is injected (e.g., into a chamber). Additionally or alternatively, a heating rate of a source material may be varied with time to vary a rate at which the source material is evaporated, vaporised, sputtered and/or sublimed.

The method may further comprise depositing a further transition layer, wherein a material from which the further transition layer is formed transitions as a function of distance between a first side of the further transition layer, at which the transition layer is formed of the core material, and a second side of the further transition layer, at which the further transition layer is formed of the cladding material.

The transition layer and the further transition layer may be referred to as a first transition layer and a second transition layer respectively.

The further (second) transition layer may have any of the properties or features of any transition layer described herein. For example, depositing the further (second) transition layer may comprise releasing a plurality of different source materials, wherein the source materials are deposited to form the deposited further (second) transition layer, and wherein a rate at which at least one of the source materials is released during the deposition of the further (second) transition layer is varied with time during the deposition so that the material composition of the further (second) transition layer being deposited varies as a function of time during the deposition.

In some examples, a first transition layer may be deposited so as to provide a transition between the core material and the cladding material at a lower surface of the waveguide core. A second transition layer may be deposited so as to provide a transition between the core material and the cladding material at an upper surface of the waveguide core. In some examples, the second transition layer may be deposited so as to further provide a transition between the core material and the cladding material at one or more side surfaces of the waveguide core.

The method may comprise depositing a layer of core material to form a bulk of the core of the waveguide.

The transition layer may be deposited before deposition of the layer of core material. The transition layer may be deposited after deposition of the layer of core material. The method may comprise depositing a first transition layer before deposition of the layer of core material and depositing a second transition layer after deposition of the layer of core material.

The layer of core material and the transition layer may be deposited in situ. For example, the same deposition process may be used to deposit the layer of core material and the transition layer. The material being deposited may be transitioned during the deposition so as to deposit both the core material and transition layer as part of the same deposition process.

The method may comprise depositing the transition layer onto the deposited layer of core material.

The deposition of the transition layer may begin with deposition of the first side of the transition layer (comprising the core material) onto the deposited layer of core material. The deposition of the transition layer may end with deposition of the second side of the transition layer.

The method may comprise etching or selectively depositing the layer of core material to form at least one side surface of the bulk of the core of the waveguide. The transition layer may be deposited after etching or selectively depositing the layer of core material such that the transition layer is deposited onto the at least side surface of the bulk of the core of the waveguide.

The bulk of the core of the waveguide may be formed using photolithography. For example, a layer of core material may be deposited and a layer of photoresist deposited onto the layer of core material. The photoresist may be exposed to patterned radiation (e.g., patterned ultraviolet radiation) to induce a chemical reaction in portions of the photoresist. The photoresist may then be developed (e.g., using a solvent) to remove either exposed or unexposed portions of the photoresist to leave a patterned mask on the layer of core material. The layer of core material may then be subjected to selective etching of the portions of the core material which are exposed through the patterned mask. The selective etching of the core material may form side surfaces of the bulk of the core of the waveguide.

Additionally or alternatively, photolithography may be used to construct a patterned mask on a layer of cladding material or on a transition layer. The patterned mask may be used to selectively deposit the layer of core material. The selective deposition of the layer of core material may form side surfaces of the bulk of the core of the waveguide.

Depositing the transition layer onto the bulk of the core of the waveguide formed through etching or selective deposition may comprise depositing the transition layer on one or more of: a layer of cladding material on which the bulk of the core of the waveguide is situated; one or more side surfaces of the bulk of the core of the waveguide; and an upper surface of the bulk of the core of the waveguide.

The layer of core material may be deposited and etched or selectively deposited to form the bulk of the core of the waveguide on a base layer of core material having a width greater than the bulk of the core of the waveguide so as to form a ridge waveguide core. The transition layer may be deposited onto the ridge waveguide core.

The method may comprise depositing a layer of cladding material on to the deposited transition layer.

The layer of cladding material may be deposited onto the second side of the transition layer (comprising the cladding material).

The layer of cladding material and the transition layer may be deposited in situ. For example, the same deposition process may be used to deposit the layer of cladding material and the transition layer. The material being deposited may be transitioned during the deposition so as to deposit both the cladding material and transition layer as part of the same deposition process.

The method may comprise depositing a layer of cladding material, wherein the transition layer is deposited onto the deposited cladding material.

Deposition of the transition layer may begin with deposition of the second side of the transition layer (comprising the cladding material) onto the layer of cladding material.

The layer of cladding material and the transition layer may be deposited in situ. For example, the same deposition process may be used to deposit the layer of cladding material and the transition layer. The material being deposited may be transitioned during the deposition so as to deposit both the cladding material and transition layer as part of the same deposition process.

The method may comprise depositing a layer of core material onto the deposited transition layer.

The layer of core material may be deposited onto the first side of the transition layer (comprising the core material).

The layer of core material and the transition layer may be deposited in situ. For example, the same deposition process may be used to deposit the layer of core material and the transition layer. The material being deposited may be transitioned during the deposition so as to deposit both the core material and transition layer as part of the same deposition process.

The photonic waveguide may comprise a multi-layer waveguide comprising a plurality of waveguide cores fabricated on top of each other with a layer of waveguide cladding in between the waveguide cores.

The transition layer may serve to reduce interlayer transitions of radiation between the different waveguide cores.

The waveguide cores may comprise the same or different core materials.

The transition layer may be deposited in between at least a first waveguide core of the multi-layer waveguide and a second waveguide core of the multi-layer waveguide core.

The second waveguide core may be fabricated on top of the first waveguide core with a layer of cladding material situated between the first waveguide core and the second waveguide core. The transition layer may be deposited on an upper surface of the first waveguide core and may provide a transition between the upper surface of the first waveguide core and the cladding material.

The second waveguide core may be deposited on the transition layer such that the transition layer provides a transition between a lower surface of the second waveguide core and the cladding material.

In some examples a first transition layer may be deposited on an upper surface of the first waveguide core to provide a transition between the upper surface of the first waveguide core and the cladding material. The second waveguide core may be deposited on a second transition layer arranged to provide a transition between a lower surface of the second waveguide core and the cladding material.

The first waveguide core of the multi-layer waveguide may have a different core material to the second waveguide core of the multi-layer waveguide.

The transition layer may provide a transition between the core material of the first waveguide core and a cladding material situated between the first waveguide core and the second waveguide core.

The transition layer providing a transition between the core material of the first waveguide core and the cladding may comprise a first transition layer. The method may comprise depositing a second transition layer, the second transition layer providing a transition between the core material of the second waveguide core and a cladding material.

The first transition layer may have a different material composition (to match the core material of the first waveguide core at a first surface of the first transition layer) to the second transition layer (to match the core material of the second waveguide core at a first surface of the second transition layer).

According to a second aspect of the disclosure there is provided a method of manufacture of a photonic waveguide, the waveguide comprising a core material and a cladding material. The method comprises: depositing and etching a layer of the core material or selectively depositing a layer of core material to form a bulk of the core of the waveguide; and depositing a film of core material onto the bulk of the core of the waveguide.

The etching or selective deposition to form the bulk of the core of the waveguide may result in surface roughness in at least one surface of the bulk of the core of the waveguide (e.g., in one or more side surfaces of the bulk of the core of the waveguide). Depositing a film of core material onto the bulk of the core of the waveguide may serve to smooth surface roughness in the at least one surface so as to form a core of the waveguide having a reduced surface roughness on at least one surface.

The method may comprise depositing a layer of cladding material onto the deposited film of core material.

According to a third aspect of the disclosure there is provided photonic waveguide manufactured according to a method of the first aspect or the second aspect.

According to a fourth aspect of the disclosure there is provided a photonic waveguide, the waveguide comprising: a core material; a cladding material arranged to encompass a portion of the core material; and a transition layer situated between at least a portion of the core material and the cladding material, wherein a material from which the transition layer is formed, transitions as a function of distance between a first side of the transition layer in contact with the core material and at which the transition layer is formed of the core material and a second side of the transition layer in contact with the cladding material and at which the transition layer is formed of the cladding material.

The waveguide may comprise a waveguide core formed of the core material. The transition layer may be arranged to provide a material transition between a lower surface of the waveguide core and the cladding material.

The waveguide may comprise a waveguide core formed of the core material and the transition layer may be arranged to provide a material transition between an upper surface of the waveguide core and the cladding material.

The waveguide may comprise a waveguide core formed of the core material and the transition layer may be arranged to provide a material transition between at least one side surface of the waveguide core and the cladding material.

The waveguide may comprise a further transition layer situated between at least a portion of the core material and at least a portion of the cladding material. A material from which the further transition layer is formed may transition as a function of distance between a first side of the further transition layer, at which the transition layer is formed of the core material, and a second side of the further transition layer, at which the further transition layer is formed of the cladding material.

The photonic waveguide may comprise a multi-layer waveguide comprising a plurality of waveguide cores fabricated on top of each other with a layer of waveguide cladding in between the waveguide cores.

The transition layer may be situated in between at least a first waveguide core of the multi-layer waveguide and a second waveguide core of the multi-layer waveguide.

The first waveguide core of the multi-layer waveguide may have a different core material to the second waveguide core of the multi-layer waveguide.

The transition layer may provide a transition between the core material of the first waveguide core and a cladding material situated between the first waveguide core and the second waveguide core.

The transition layer providing a transition between the core material of the first waveguide core and the cladding may comprise a first transition layer. The waveguide may further comprise a second transition layer, the second transition layer providing a transition between the core material of the second waveguide core and a cladding material.

Processes are described herein that may reduce lower, upper, and/or lateral (side) roughness at one or more waveguide to cladding interfaces using deposition processes that form a transition or blend between the cladding and waveguide core material during a deposition process. The deposition process may, for example, use Chemical Vapour Deposition (CVD), Plasma Enhanced CVD (PECVD), Low-Pressure CVD (LPCVD), sputtering evaporation, molecular beam epitaxy (MBE) and/or other suitable deposition process.

In some examples, a Si₃N₄/SiO₂ material waveguide system may be used in which a core material comprises Si₃N₄ and a cladding material comprises SiO₂. In such examples, PECVD or LPCVD deposition systems may be used to continually alter feed rates and relative pressures of the source gases used during deposition to transition from a pure Si₃N₄ film, to a SiOₓN_{y} film (where x varies from 0 to 2, and y varies from 4 to 0), to a pure SiO₂ film (or vice-versa). A similar grading (transition) of materials during deposition in-situ may be performed on sputtering systems with multiple targets in-chamber, and the source power applied to each target may be adjusted in-situ.

The present disclosure is not, however, limited to the use of Si₃N₄/SiO₂ material waveguide systems, and can be applied, for example, to Si/SiO₂, TiO₂/SiO₂ and many other types of systems where both waveguide (core) and cladding materials can be deposited in a single tool.

Examples are disclosed herein in which a multiple integration method is used to induce a blending (transition) of materials from the waveguide core to the cladding (or vice versa). An example, method may use: a substrate material for loading a cladding material, a waveguide (core) material, and a cladding material. Grading of a material interface of waveguide (core) and cladding materials may be performed through in-situ film transition during deposition.

In some examples, a method may comprise integrations enabling the grading (transition) of at least one of an upper interface, a lower interface, upper and lower interfaces, lateral (side) and upper interfaces, and lateral (side), upper, and lower interfaces.

In some examples, a method may comprise a deposition of waveguide (core) material which is then continuously adjusted to create a film that blends (transitions) from the waveguide (core) material to a cladding material towards the end of the process. A waveguide may be patterned with lithography and etched down to a bottom cladding layer. After photoresist cleans, an upper cladding may be deposited to result in an improved waveguide with reduced roughness.

In some examples, a method may comprise a continually graded deposition also applied to a lower cladding surface. In particular, when the existing bottom cladding has high roughness from previous processes or when part of a more complex integration stack.

In some examples, graded sidewalls may be provided as well. This may be applied when the waveguide (core) is narrow and the optical mode has significant overlap with the lateral interface between the waveguide (core) and the cladding. In such examples, the waveguide (core) material may be deposited directly on the lower cladding material. The waveguide may be patterned with lithography, etched, and cleaned to remove the photoresist. At this point, a graded deposition may start with the waveguide (core) material and transitions to the cladding material. In this process the deposition may take place on the waveguide (core) top surface, side surfaces, and along the surface of the lower cladding. This in effect forms a “ridge” waveguide. Moreover, the graded deposition may maintain the pure waveguide (core) material for some time before transitioning to the cladding material to define a specific “ridge” height.

In some examples, the methods disclosed herein may be applied to a bottom interface between the waveguide (core) and the lower cladding. A graded film transitioning between the cladding and waveguide (core) material may be deposited directly onto the lower cladding, and transition into the pure waveguide (core) material as discussed above. After waveguide patterning, the waveguide may be etched to some point above the lower cladding grading transition so as to maintain the gradation in the slab portions of the ridge waveguide. The photoresist is then stripped, and the continuously graded upper film as discussed above, is applied. Further the upper cladding film can be deposited in-situ or separately.

In some examples, the graded film can be applied to any or all of the interfaces to reduce propagation loss. However, depending on the waveguide optical confinement, the waveguide width may be wide enough to avoid modal overlap with the side roughness. In such a case, the simplest implementations with only upper and lower graded transitions may be used.

In some examples, the described method may also apply to a wide variety of deposition systems including LPCVD, PECVD, CVD, sputtering, evaporation, and/or MBE.

Described methods may provide waveguide structures with high precision and reproducibility to ensure high-quality waveguide structures with low loss and high efficiency. The disclosed methods may reduce optical losses which are created due to surface roughness or other imperfections that directly interacts with the guided light that leads to photon scattering and results in significant impact on the waveguide performance such as confinement mode, optical losses, and sensitivity to external perturbations. This scattering increases the propagation loss of the waveguide, which impacts the overall system performance by decreasing the efficiency.

Methods and devices disclosed herein advantageously offer the technical effects/advantages such as the production of high performance and low-loss waveguide layers, supports more on-chip functionality, reduces laser source power requirements, creates higher quality factor ring resonators, and reduces optical scattering, and thus energy losses, as light travels through the waveguide. The loss may be reduced by carefully selecting the waveguide material and the design parameters of the waveguide such as the width and height of the waveguide.

It will be appreciated from the foregoing disclosure and the following detailed description of the examples that certain features and implementations described as being optional in relation to any given aspect of the disclosure set out above should be understood by the reader as being disclosed also in combination with the other aspects of the present disclosure, where applicable. Similarly, it will be appreciated that any attendant advantages described in relation to any given aspect of the disclosure set out above should be understood by the reader as being disclosed as advantages of the other aspects of the present disclosure, where applicable. That is, the description of optional features and advantages in relation to a specific aspect of the disclosure above is not limiting, and it should be understood that the disclosures of these optional features and advantages are intended to relate to all aspects of the disclosure in combination, where such combination is applicable.

### BRIEF DESCRIPTION OF THE DRAWINGS

Certain examples of the present disclosure will now be described, with reference to the accompanying drawings, in which:

FIG. 1 is a schematic illustration of a cross-section of an example waveguide structure;

FIG. 2 is a schematic illustration of a cross-section of an example waveguide structure during several stages of a method of manufacture;

FIG. 3 is a schematic illustration of a cross-section of a further example waveguide structure during several stages of a method of manufacture;

FIG. 4 is a schematic illustration of a cross-section of a still further example waveguide structure during several stages of a method of manufacture;

FIG. 5 is a schematic illustration of a cross-section of a still further example waveguide structure during several stages of a method of manufacture;

FIG. 6 is a schematic illustration of a cross-section of a still further example waveguide structure during several stages of a method of manufacture;

FIG. 7 is a schematic illustration of an example of a multi-layer waveguide;

FIG. 8 is a flowchart of a method of manufacture of a waveguide; and

FIG. 9 is a schematic illustration of a cross-section of an example waveguide at stages during a method of manufacture according to the method of FIG. 8.

### DETAILED DESCRIPTION

Hereinafter, examples of the disclosure are described with reference to the accompanying drawings. However, it should be appreciated that the disclosure is not limited to the described examples, and all changes and/or equivalents or replacements thereto also belong to the scope of the disclosure. The same or similar reference denotations may be used to refer to the same or similar elements throughout the specification and the drawings.

As used herein, the terms “have,” “may have,” “include,” or “may include” a feature (e.g., a number, function, operation, or a component such as a part) indicate the existence of the feature and do not exclude the existence of other features. Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

As used herein, the terms “A or B,” “at least one of A and/or B,” or “one or more of A and/or B” may include all possible combinations of A and B. For example, “A or B,” “at least one of A and B,” “at least one of A or B” may indicate all of (1) including at least one A, (2) including at least one B, or (3) including at least one A and at least one B.

As used herein, the terms “first” and “second” may modify various components regardless of importance and do not limit the components. These terms are only used to distinguish one component from another. For example, reference to a first component and a second component may indicate different components from each other regardless of the order or importance of the components.

It will be understood that when an element (e.g., a first element) is referred to as being (physically, operatively or communicatively) “coupled with/to,” or “connected with/to” another element (e.g., a second element), it can be coupled or connected with/to the other element directly or via a third element. In contrast, it will be understood that when an element (e.g., a first element) is referred to as being “directly coupled with/to” or “directly connected with/to” another element (e.g., a second element), no other element (e.g., a third element) intervenes between the element and the other element.

The terms as used herein are provided merely to describe some embodiments thereof, but not to limit the scope of other embodiments of the disclosure. It is to be understood that the singular forms “a,” “'an,” and “the” include plural references unless the context clearly dictates otherwise. All terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

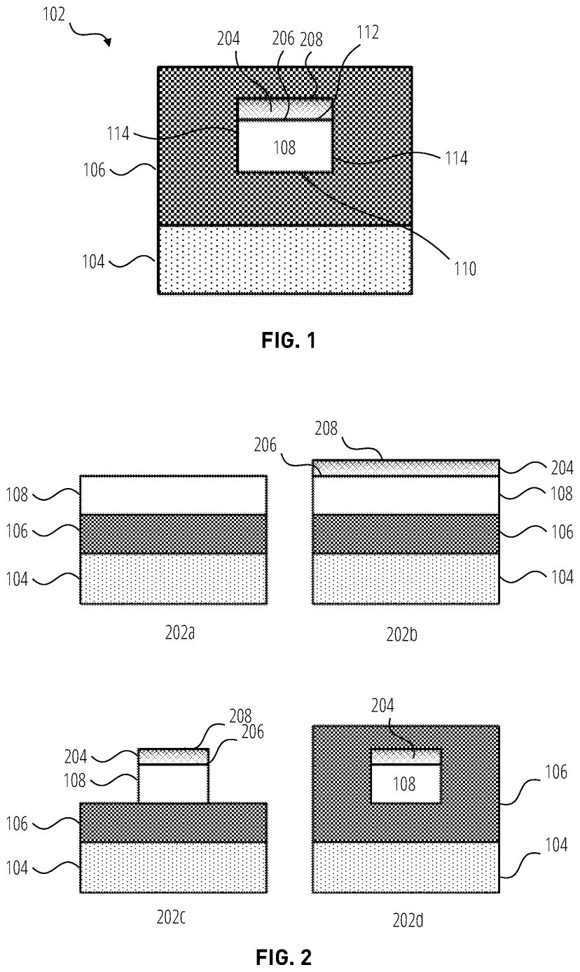

FIG. 1 is a schematic illustration of a cross-section of a waveguide structure 102 according to examples, disclosed herein. The waveguide structure 102 shown in FIG. 1 is a rectangular (strip) buried waveguide. However, this type of waveguide is presented merely as an illustrative example and similar principles to those described herein may also apply to other waveguide shapes.

The waveguide structure 102 comprises a cladding material 106 deposited on a substrate 104. A core material 108 is buried in the cladding material 106 such that the core material 108 is encompassed by the cladding material 106 in two-dimensions (such that a portion of core material 108 is encompassed by the cladding material 106). The core material 108 forms the waveguide along which light can propagate. The core material 108 has a higher refractive index than the cladding material 106 such that light propagating through the core material 108 is confined to the core material 108 through refraction and total internal reflection. A waveguide structure 102 is also typically arranged to confine an optical mode within the core material 108.

Whilst not shown in FIG. 1, in practice the waveguide structure 102 will extend in directions into and/or out of the page shown in FIG. 1, with a generally similar cross-section to that which is shown in FIG. 1. At ends of the waveguide structure 102, the core material 108 is exposed (i.e., not encompassed by cladding material 106) to allow light to enter and exit the waveguide structure 102 at its ends. For this reason the core material 108 is only encompassed by the cladding material 106 in two-dimensions. Equivalently the cladding material 106 may be described as encompassing a portion of the core material 108 (i.e., not including ends of the waveguide core).

The waveguide structure 102 shown in FIG. 1 includes a number of interfaces between the core material 108 and the cladding material 106. These may be referred to as a lower interface 110, an upper interface 112 and side interfaces 114. Side interfaces 114 may alternatively be referred to as lateral interfaces 114. References herein to directional arrangements such as upper, lower and side (or lateral) are intended to describe arrangements relative to the rest of the waveguide structure 102 and do not imply any absolute orientation (for example, in a lab frame).

A lower interface 110 may generally describe an interface 110 between the core material 108 and cladding material 106 which is closest (of all of the interfaces for that waveguide core) to a substrate 104 on which the waveguide is arranged. The lower interface 110 may generally extend parallel to a surface of the substrate 104 on which the cladding material 106 is situated (although other arrangements are possible).

An upper interface 112 may generally describe an interface 112 which is furthest (of all of the interfaces for that waveguide core) to the substrate 104 on which the waveguide is arranged. The upper interface 112 may generally extend parallel to a surface of the substrate 104 on which the cladding material 106 is situated (although other arrangements are possible).

Side interfaces 114 (which may be referred to as lateral interfaces) may generally describe interfaces 114 which extend in a direction extending between a lower interface 110 and an upper interface 112. Side interfaces 114 may extend in a direction which is not parallel to (and may be perpendicular to) a surface of the substrate 104 on which the cladding material 106 is situated.

Whilst a simple rectangular (strip) buried waveguide structure 102 is shown in FIG. 1, other waveguide structures and shapes may be used. For example, planar, strip, ridge, rib shapes and/or any other suitable waveguide shape may be used. Such structures may include additional and/or alternative interfaces to those described with reference to the waveguide structure 102 of FIG. 1. In general, all waveguide structures will include one or more interfaces between a core material 108 and a cladding material 106.

As was described above, interfaces between a core material 108 and a cladding material 106 may be a source of optical loss. For example, surface roughness present at interfaces between a core material 108 and a cladding material 106 may be a source of photon scattering which leads to a loss of photons from the waveguide core.

Methods of manufacture and waveguide structures are described herein which provide a material transition (in the form of one or more transition layers) between a core material 108 and a cladding material 106 so as provide a transitional interface between the core material 108 and cladding material 106 which results in reduced optical loss. In particular, methods of manufacture are described herein which include the deposition of a transition layer 204. In the example, shown in FIG. 1 a transition layer 204 is provided at the upper interface 112 between the core material 108 and the cladding material 106. As will be described in further detail below, in other examples, a transition layer 204 may be provided at additional and/or alternative interfaces between the core material 108 and the cladding material 106.

A material from which the transition layer 204 is formed transitions as a function of distance between a first side 206 of the transition layer 204, at which the transition layer 204 is formed of a core material 108, and a second side 208 of the transition layer at which the transition layer 204 is formed of the cladding material 106. As shown in the example of FIG. 1, a transition layer 204 (or at least part of a transition layer 204) is usually arranged such that the first side 206 (comprising the core material 108) is in contact with the core material 108 and the second side 208 (comprising the cladding material 106) is in contact with the cladding material 106.

The material composition of a transition layer 204 between the first side 206 (at which the transition layer is formed of the core material 108) and the second side 208 (at which the transition layer 204 is formed of the cladding material 106) comprises an intermediate material. The intermediate material may comprise components of the core material 108 and components of the cladding material 106. The composition of the transition layer 204 (and the intermediate material) varies as a function of distance between the first side 206 and the second side 208 of the transition layer 204. The composition of the transition layer 204 (and the intermediate material) may vary continuously between the first side 206 and the second side 208. That is, there may be no substantial discontinuities in the material composition of the transition layer 204 as a function of distance between the first side 206 and the second side 208.

Due to the transition of material in the transition layer 204 between the core material 108 (at the first side 206 of the transition layer 204) and the cladding material 106 (at the second side 208 of the transition layer 204), the refractive index of the transition layer may also vary as a function of distance between the first side 206 (at which the refractive index is that of the core material 108) and the second side 208 (at which the refractive index is that of the cladding material 106) of the transition layer 204. Similarly to the material composition of the transition layer 204, the refractive index of the transition layer 204 may vary as a continuous function of distance between the first side and the second side of the transition layer. That is, there may be no substantial discontinuities in the refractive index of the transition layer 204 as a function of distance between the first side 206 and the second side 208.

The transition layer 204, in which the material composition and refractive index is gradually transitioned between the core material 108 and the cladding material 106, reduces photon scattering which occurs at an interface between the core material 108 and the cladding material 106. As was explained above, photon scattering may occur as a result of surface roughness at a sharp discontinuity in material composition and/or refractive index. A transition layer 204 as described herein serves to smooth any such discontinuities so as to reduce photon scattering events and optical loss in the waveguide.

In the examples, described herein any suitable materials and deposition methods may be used. In some examples, a suitable core material 108 may comprise silicon nitride (Si₃N₄) and a suitable cladding material 106 may comprise silicon dioxide (SiO₂). In such examples, the transition layer may be formed of SiOₓN_{y} where x varies between 0 and 2 as a function of distance between the first side 206 of the transition layer 204 and the second side 208 of the transition layer 204 and y varies between 4 and 0 as a function of distance between the first side 206 of the transition layer 204 and the second side 208 of the transition layer 204.

In some examples, a suitable core material 108 may comprise silicon (Si) and a suitable cladding material 106 may comprise SiO₂. In such examples the transition layer 204 may be formed of SiOₓ where x varies between 0 and 2 as a function of distance between the first side 206 of the transition layer 204 and the second side 208 of the transition layer 204.

In some examples, a suitable core material 108 may comprise titanium dioxide (TiO₂) and a suitable cladding material 106 may comprise SiO₂. In such examples the transition layer 204 may be formed of TiₓO₂ where x varies between 1 and 0 as a function of distance between the first side 206 of the transition layer 204 and the second side 208 of the transition layer 204.

Whilst some example materials and material combinations have been explicitly described herein, the described methods and apparatus are not limited to the material combinations which are explicitly described and any suitable materials which may be deposited in waveguide manufacture may be used.

Suitable deposition methods for forming the cladding material 106, core material 108 and/or transition layer 204 may include Chemical Vapour Deposition (CVD), Physical Vapour Deposition (PVD) and/or Molecular Beam Epitaxy (MBE) deposition. A CVD may include one or more of Low-Pressure CVD (LPCVD), Ultrahigh Vacuum (UHVCVD) and/or Plasma-Enhanced CVD (PECVD). A PVD may include one or more of sputtering and/or evaporative deposition (which may include, for example, electron beam evaporation, thermal evaporation, cathodic arc evaporation, and/or laser evaporation etc.). In general, any suitable deposition method may be used to form the core material 108 and/or cladding material 106.

In order to achieve the above described material transition in the transition layer 204, the transition layer 204 may be formed using a deposition method which comprises releasing a plurality of source materials and varying a rate at which at least one of the source materials is released during decomposition. For example, deposition methods such as CVD, PVD and MBE all include the release of source materials into a chamber (e.g., vacuum chamber) in which a deposition surface (a surface onto which a material is to be deposited) is situated. The source materials may interact with each other and/or the deposition surface to form the transition layer 204. The material composition of the transition layer 204 therefore depends, at least in part, on the relative pressures or concentrations of source materials in the environment (e.g., in a chamber) surrounding the deposition surface. The relative pressures or concentrations of source materials in the environment surrounding the deposition surface may be controlled by controlling a rate (per unit time) at which source materials are released. In this way, the material composition of the transition layer 204 may be transitioned during deposition by changing a rate at which at least one of the source materials is released during deposition.

A rate at which at least one of the source materials is released may be varied as a function of time during deposition of the transition layer 204 so as to vary the material composition as a function of distance between a first side 206 and second side 208 of a deposited transition layer 204. Depending on the source materials and the core and cladding materials between which the transition layer 204 transitions, a rate of release of a single source material may be varied during deposition (e.g., whilst a rate of release of another source material is held constant) or rates of release of a plurality of source materials may be varied during deposition.

Depending on the deposition process being used, source materials may be released through one or more of injecting gaseous source materials, and/or evaporating, vaporising, sputtering and/or sublimation of source materials. A rate of release of a source material may be varied with time, for example, by varying a flow rate of a gaseous source material as it is injected into a chamber. A rate of release of a source material may alternatively be varied by varying a rate at which a source material is evaporated, vaporised, sputtered and/or sublimed. For example, a heating rate of a material which results in evaporation, vaporisation, sputtering and/or sublimation may be varied in order to vary a rate at which the material is released.

In general, any suitable deposition method which includes the release of a plurality of source materials which interact with each other and/or a surface onto which a material is deposited may be used to form a transition layer 204 as described herein.

Whilst the waveguide structure 102 of FIG. 1 includes a single transition layer 204 situated at an upper interface 112 between a core material 108 and a cladding material 106, there are many variations as to how one ore more transition layers as described herein may be incorporated into a waveguide structure. Several examples are described below with reference to FIG. 2-FIG. 7. Any of the examples disclosed herein (including those described below with reference to FIG. 2-FIG. 7) may include any of the features described above with reference to FIG. 1. For example, any transition layers 204 described herein may include any of the features and/or material compositions of the transition layer 204 described above with reference to FIG. 1. Similarly, any transition layers 204 described herein may be deposited using any of the features of a deposition process as described above with reference to the transition layer 204 of FIG. 1. Furthermore, any core material and/or cladding material described herein may include any of the features of the core material 108 and cladding material 106 described above with reference to FIG. 1.

A common set of reference numerals is used throughout the figures to denote corresponding components and features. A detailed description of each component or feature is not provided with reference to each example and Figure.

FIG. 2 is a schematic illustration of a cross-section of a waveguide structure during several stages of a method of manufacture according to examples disclosed herein. The method begins at a first stage 202a at which a layer of cladding material 106 is deposited onto a substrate 104. A layer of core material 108 is then deposited onto the cladding material 106. Any suitable deposition process may be used to form the cladding material 106 and the core material 108 such as CVD, PVD and/or MBE. One or both of the cladding material 106 and core material 108 may undergo additional processes after deposition such as cleaning to remove contaminants or impurities. One or both of the cladding material 106 and core material 108 may be subjected to a Chemical Mechanical Polishing (CMP) process. A CMP process uses chemical oxidation and mechanical abrasion to remove material and helps to planarize an upper surface of a material layer.

An upper surface of the core material 108 may include some surface roughness, which may be a result of the deposition process used to deposit the core material 108 and/or one or more additional processes (such as CMP) applied to the core material 108 after deposition. In order to reduce the effects of any such surface roughness (such as photon loss), a transition layer 204 is deposited on the layer of core material 108 as shown in a second stage 202b in FIG. 2. The transition layer 204 is deposited in-situ and the transition of material in the transition layer 204 is achieved through in-situ deposition.

Deposition of the transition layer 204 begins with deposition of a first side 206 of the transition layer 204 onto an upper surface of the core material. As was explained above, at the first side 206 of the transition layer 204, the transition layer 204 is formed from the core material 108. The material composition of the transition layer 204 is varied as a function of time during deposition such that the material composition varies as a function of distance between the first side 206 (at which the transition layer 204 is formed of the core material 108) and a second side 208 (at which the transition layer 204 is formed of the cladding material 106).

In some examples, the layer of core material 108 and the transition layer 204 may be deposited in a single in-situ deposition. For example, at the end of deposition of the core material 108 a rate of release of at least one source material may be varied during deposition to begin deposition of the transition layer 204 as part of the same deposition process. Furthermore, in some examples, the deposition of the cladding material 106, core material 108 and transition layer 204 may all be performed in-situ (e. g, as part of the same deposition process).

After deposition of the transition layer 204, the waveguide is subjected to a selective etching process to remove portions of the core material 108 (and transition layer 204) and to form the waveguide core. The resulting structure is shown in a third stage 202c in FIG. 2. The selective etching process may be facilitated through the use of photolithography. For example, whilst not shown in FIG. 2, between the second stage 202b and the third stage 202c a photoresist may be deposited on the transition layer 204. The photoresist may then be exposed to a patterned beam of radiation (e.g., UV radiation). The patterned photoresist may then be developed (e.g., using a solvent) to remove a portion of the photoresist (which may comprise the portion of photoresist which was exposed to radiation or the portion which was not exposed to radiation depending on the type of photoresist used). Such a process may be performed such that the portion of core material 108 which is to form the waveguide core remains with photoresist on it (with the transition layer 204 situated between the core material 108 and the photoresist), whereas other portions are exposed. An etching process is then applied to etch the exposed portions of core material 108 and transition layer 204 down to the cladding material 106 to leave the structure shown in a third stage 202c of FIG. 2. Remaining surfaces may then be subjected to a cleaning process.

Following etching, further cladding material 106 is deposited to encompass the core material 108 and transition layer 204 as shown in a fourth stage 202d of FIG. 2. The resulting waveguide structure as shown in the fourth stage 202d of FIG. 2 corresponds to the waveguide structure 102 described above with reference to FIG. 1.

As an alternative to the selective etching process described above and depicted in FIG. 2, the waveguide core may instead be formed through selective deposition. For example, a photoresist may be deposited onto the cladding material 106 prior to deposition of the core material 108. Photolithography and resist development may then be performed to expose a portion of the cladding material 106 on which the waveguide core is to be formed. A layer of core material 108 followed by a transition layer 204 may then be deposited into the region exposed by photolithography to perform a selective deposition of the core material 108 and transition layer 204 to form the waveguide core. Such a process may be used to achieve the structure shown in the third stage 202c of FIG. 2, which similarly may be followed by deposition of a cladding material 106 to achieve the structure shown in the fourth stage 202d of FIG. 2.

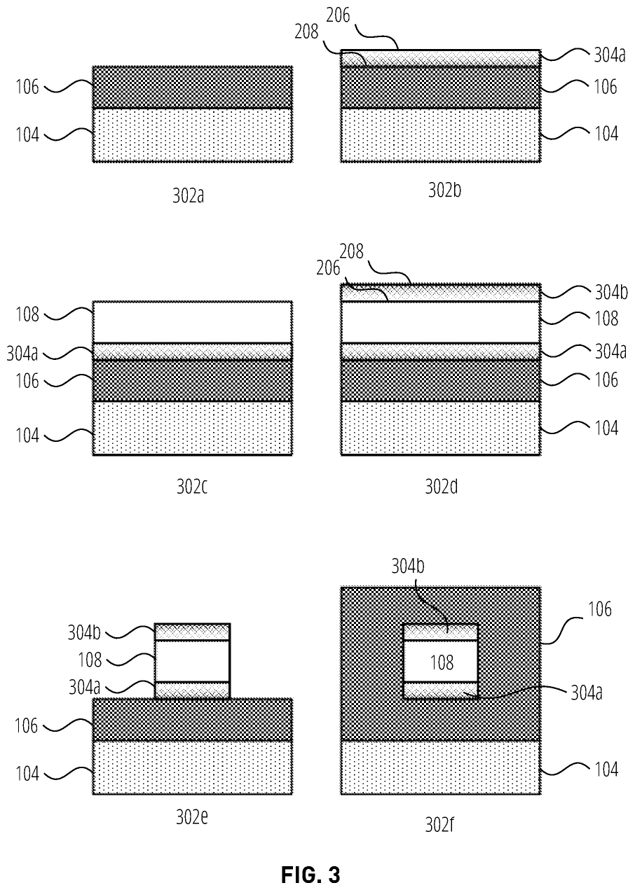

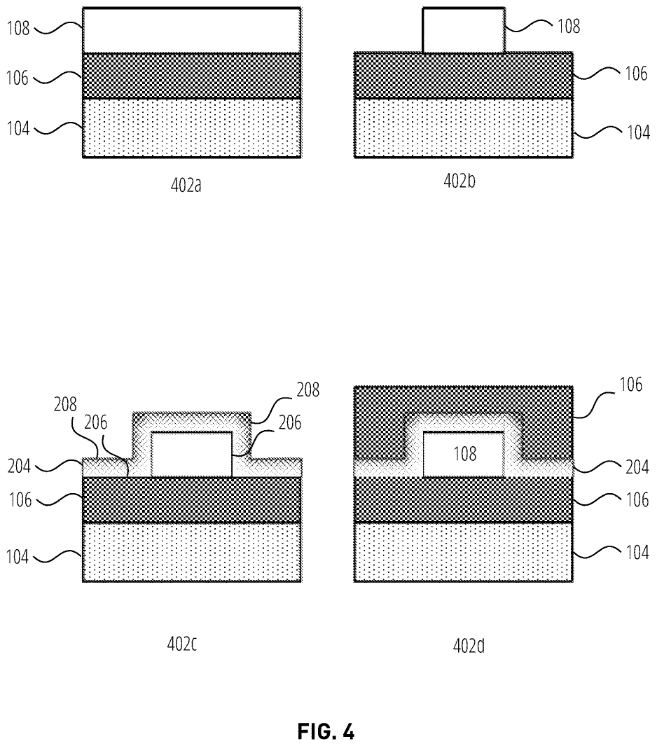

FIG. 3 is a schematic illustration of a cross-section of a further waveguide structure during several stages of a method of manufacture according to examples disclosed herein. The method begins at a first stage 302a at which a cladding material 106 is deposited onto a substrate 104. A first transition layer 304a is then deposited on the cladding material 106 as shown in a second stage 302b in FIG. 3. Whilst a different reference numeral 304a is used to denote the first transition layer 304a to the reference numeral used to denote a transition layer 204 in other Figures (in order to differentiate between a first 304a and second 304b transition layer in FIG. 3), the first transition layer 304a may share any of the features and/or methods of deposition as any other transition layer 204 described herein.

Deposition of the first transition layer 304a begins with a second side 208 of the first transition layer 304a, at which the first transition layer 304a is formed of the cladding material 106. Since the first transition layer 304a is deposited onto the cladding material 106, this ensures that the second side 208 of the first transition layer 304a interfaces with the cladding material 106. Deposition of the first transition layer 304a ends with a first side 206 of the first transition layer 304a at which the first transition layer 304a is formed of the core material 108. The first transition layer 304a is deposited in-situ and the transition of material in the first transition layer 304a is achieved through in-situ deposition.

A layer of core material 108 is then deposited onto the first side 206 of the first transition layer 304a to result in the structure shown in a third stage 302c of FIG. 3. Since the first side 206 of the first transition layer 304a is composed of the core material 108, the core material 108 interfaces with a side of the first transition layer 304a which is composed of core material 108, thereby avoiding a sharp discontinuity in material composition (and refractive index) at a lower interface of the core material 108.

A second transition layer 304b is then deposited onto the core material 108 resulting in the structure shown in a fourth stage 302d of FIG. 3. Whilst a different reference numeral 304b is used to denote the second transition layer 304b to the reference numeral used to denote a transition layer 204 in other Figures (in order to differentiate between a first 304a and second 304b transition layer in FIG. 3), the second transition layer 304b may share any of the features and/or methods of deposition of any other transition layer 204 described herein.

Deposition of the second transition layer 304b begins with a first side 206 of the second transition layer 304b, at which the second transition layer 304b is formed of the core material 108. Since the second transition layer 304b is deposited onto the core material 108, this ensures that the first side 206 of the second transition layer 304b interfaces with the core material 108. Deposition of the second transition layer 304b ends with a second side 208 of the second transition layer 304b, at which the second transition layer 304b is formed of the cladding material 106. The second transition layer 304b is deposited in-situ and the transition of material in the second transition layer 304b is achieved through in-situ deposition.

In some examples, two or more of the layer of cladding material 106, first transition layer 304a, layer of core material 108 and the second transition layer 304b may be deposited in a single in-situ deposition.

The structure shown in fourth stage 302d of FIG. 3 is then subjected to a selective etching process to remove portions of the core material 108, first transition layer 304a and second transition layer 304b to form the waveguide core. The resulting structure is shown in a fifth stage 302e in FIG. 3. The selective etching process may correspond to the selective etching process described above with reference to FIG. 2. For example, a photoresist and photolithography may be used to expose portions of the core material (and transition layers) which are subjected to an etching process to form the waveguide core. Etching may be followed by a cleaning process.

As was described above, with reference to FIG. 2 as an alternative to the selective etching process depicted in FIG. 3, the waveguide core may instead be formed through selective deposition.

Following the formation of the waveguide core as shown in the fifth stage 302e of FIG. 3, further cladding material 106 is deposited to encompass the core material 108 and transition layers 304a, 304b as shown in a sixth stage 302f of FIG. 3. The resulting waveguide structure, as shown in the sixth stage 302f of FIG. 3, is similar to the waveguide structure 102 described above with reference to FIG. 1 and FIG. 2 except that a transition layer 304a, 304b is provided at both of upper and lower interfaces between the core material 108 and the cladding material 106. Photon loss may therefore be reduced at both the upper and lower interfaces in the waveguide structure shown in FIG. 3.

FIG. 4 is a schematic illustration of a cross-section of a still further waveguide structure during several stages of a method of manufacture according to examples disclosed herein. The method begins at a first stage 402a at which a cladding material 106 is deposited onto a substrate 104 followed by deposition of core material 108 onto the cladding material 106.

The core material 108 is then subjected to a selective etching to remove portions of the core material 108 to form a waveguide core as shown in a second stage 402b in FIG. 4. The selective etching process may correspond to the selective etching process described above with reference to FIG. 2. For example, a photoresist and photolithography may be used to expose portions of the core material 108 which are subjected to an etching process to form the waveguide core. Etching may be followed by a cleaning process. As an alternative to the selective etching process depicted in FIG. 4, the waveguide core may instead be formed through selective deposition.

A transition layer 204 is then deposited on to the core material 108 and exposed portions of the cladding material 106 as shown in a third stage 402c in FIG. 4. Deposition of the transition layer 204 begins with a first side 206 of the transition layer 204 at which the transition layer 204 is formed of the core material 108. This ensures that the first side 206 of portions of the transition layer 204 which are deposited onto the core material 108 interface with the core material 108. Deposition of the transition layer 204 ends with a second side 208 of the transition layer 204 at which the transition layer 204 is formed of the cladding material 106. The transition layer 204 is deposited in-situ and the transition of material in the second transition layer 304b is achieved through in-situ deposition.

As is shown in the third stage 402c of FIG. 4, the transition layer 204 is deposited on an upper surface of the core material 108 on side surfaces of the core material 108 and exposed portions of the cladding material 106. On the upper surface of the core material 108 and the side surfaces of the core material 108, the first side 206 of the transition layer 204 (which is formed of the core material 108) is in contact with core material 108 so as to provide a gradual material transition from the core material 108. Where the transition layer 204 is also deposited on exposed portions of the cladding material 106, the first side 206 of the transition layer 204 (which is formed of the core material 108) is in contact with the cladding material 106 so as to produce a discontinuity in material composition (and refractive index) at the interface between the transition layer 204 and the core material 108. However, since this interface does not form part of the outer extent of the bulk of the waveguide core it may not be a significant source of photon loss.

The portion of the transition layer 204 which is deposited on the exposed portions of the cladding material 106 may serve to form a ridge waveguide structure. In some examples, the thickness of the transition layer 204 may be increased and/or the deposition may begin with an extended period of deposition of pure core material 108 (before the material composition is transitioned to the cladding material 106) in order to form a ridge waveguide structure.

After deposition of the transition layer 204, further cladding material 106 is deposited to encompass the core material 108 and a portion of the transition layer 204 as shown in a fourth stage 402d of FIG. 4. The resulting waveguide structure as shown in FIG. 4 includes a transition of material at an upper interface between the waveguide core and the cladding material 106 and at side surfaces of the waveguide core.

In some examples, the transition layer 204 and the cladding material 106 deposited on the cladding material 106 may be deposited in a single in-situ deposition.

Providing a transition layer 204 at side interfaces between the core material 108 and the cladding material 106 may be particularly applicable in examples in which the waveguide core is relatively narrow and/or an optical mode has significant overlap with the side surfaces of the waveguide core. Furthermore, the side surfaces may be formed by selective etching or selective deposition which are processes which may be a significant source of surface roughness (e.g., as a result of line edge roughness produced by photolithography). A transition layer on side surfaces of the waveguide core may therefore, for at least some waveguide structures, be particularly effective at reducing optical loss in the waveguide.

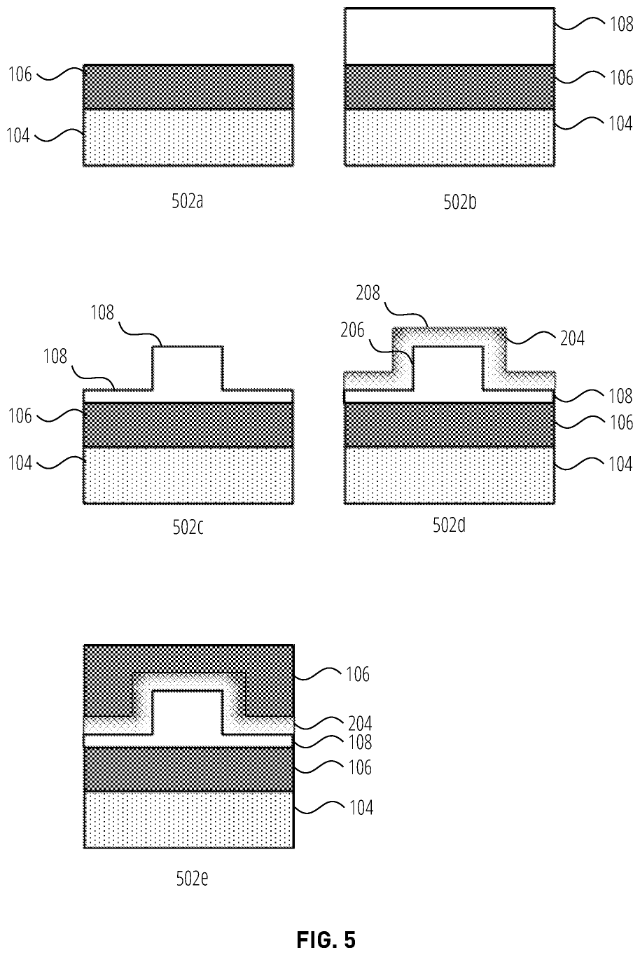

FIG. 5 is a schematic illustration of a cross-section of a still further waveguide structure during several stages of a method of manufacture according to examples disclosed herein. The method depicted in FIG. 5 is similar to the method depicted in FIG. 4 except that a ridge waveguide core structure is initially deposited.

The method begins at a first stage 502a at which a cladding material 106 is deposited onto a substrate 104. A layer of core material 108 is then deposited onto the cladding material 106 as shown in a second stage 502b in FIG. 5.

The core material 108 is then subjected to a selective etching process to remove portions of the core material 108 to form a waveguide core as shown in a third stage 502c in FIG. 5. In contrast to the selective etching process of FIG. 4, in the selective etching process of FIG. 5 at least a portion of the etched core material 108 is not etched right down to the cladding material 106 so as to form a ridge waveguide core structure as shown in the third stage 502c.

The selective etching process may correspond to the selective etching process described above with reference to FIG. 2. For example, a photoresist and photolithography may be used to expose portions of the core material 108 which are subjected to an etching process to form the waveguide core. Etching may be followed by a cleaning process. As an alternative to the selective etching process depicted in FIG. 5, the waveguide core may instead be formed through selective deposition.

In some examples, a ridge waveguide structure may be formed through any suitable combination of selective etching and deposition steps. For example, a rectangular waveguide core could be formed, for example, through selective etching of the layer of core material 108. A subsequent deposition of core material 108 may then be performed to deposit further core material 108 on the top of the rectangular waveguide core and at least a portion of the cladding material 106 to form the ridge waveguide shape shown in the third stage 502c of FIG. 5. This deposition of core material 108 could, for example, form an initial phase of depositing a transition layer 204.

A transition layer 204 is then deposited on to the core material 108 as shown in a fourth stage 502d in FIG. 5. Deposition of the transition layer 204 begins with a first side 206 of the transition layer 204 at which the transition layer 204 is formed of the core material 108. This ensures that the first side 206 of portions of the transition layer 204 which are deposited onto the core material 108 interface with the core material 108. Deposition of the transition layer 204 ends with a second side 208 of the transition layer 204 at which the transition layer 204 is formed of the cladding material 106. The transition layer 204 is deposited in-situ and the transition of material in the second transition layer 304b is achieved through in-situ deposition.

As is shown in the fourth stage 502d of FIG. 5, the transition layer 204 is deposited on an upper surface of the bulk of the core material 108, on side surfaces of the bulk of the core material 108 and an upper surface of the portions of core material which extend laterally from the bulk of the core material 108. At these interfaces, the first side 206 of the transition layer 204 (which is formed of the core material 108) is in contact with core material 108 so as to provide a gradual material transition from the core material 108.

After deposition of the transition layer 204, further cladding material 106 is deposited to encompass the core material 108 and a portion of the transition layer 204 as shown in a fifth stage 502e of FIG. 5. The resulting waveguide structure as shown in FIG. 5 includes a transition of material at an upper interface between the waveguide core and the cladding material 106 and side surfaces of the waveguide core as well as the laterally extending portions of the ridge shaped waveguide core. In some examples, the transition layer 204 and the cladding material 106, which is deposited on the transition layer 204 may be deposited in a single in-situ deposition.

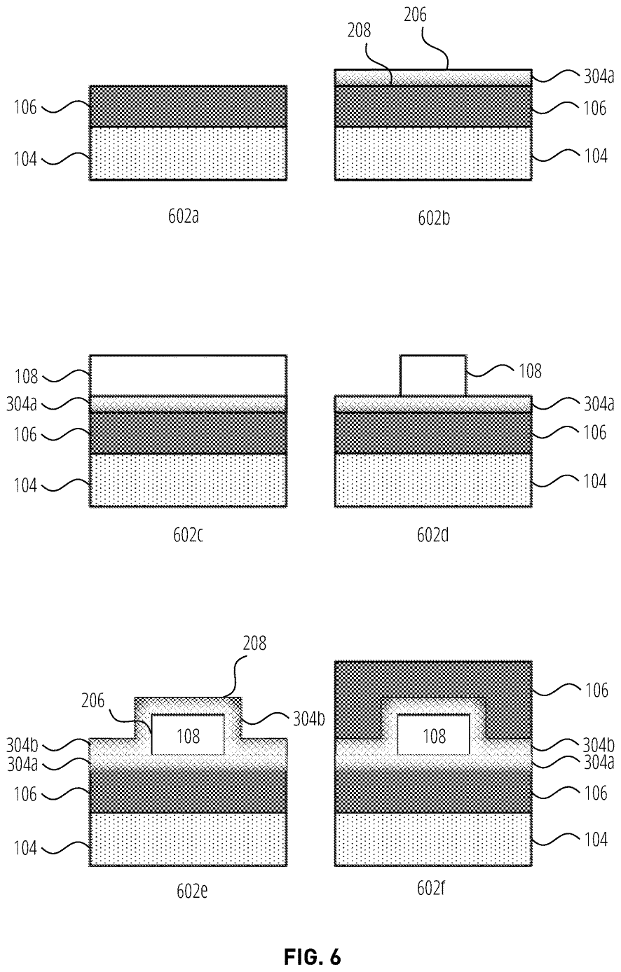

FIG. 6 is a schematic illustration of a cross-section of a still further waveguide structure during several stages of a method of manufacture according to examples disclosed herein. The method depicted in FIG. 6 is similar to the method depicted in FIG. 4 except that a transition layer is also provided at a lower interface between the waveguide core and the cladding material 106.

The method begins at a first stage 602a at which a cladding material 106 is deposited onto a substrate 104. A first transition layer 304a is then deposited onto the cladding material 106 as shown in a second stage 602b in FIG. 6. Whilst a different reference numeral 304a is used to denote the first transition layer 304a to the reference numeral used to denote a transition layer 204 in other Figures (in order to differentiate between a first 304a and second 304b transition layer in FIG. 6), the first transition layer 304a may share any of the features and/or methods of deposition as any other transition layer 204 described herein.

Deposition of the first transition layer 304a begins with a second side 208 of the first transition layer 304a at which the first transition layer 304a is formed of the cladding material 106. Since the first transition layer 304a is deposited onto the cladding material 106, this ensures that the second side 208 of the first transition layer 304a interfaces with the cladding material 106. Deposition of the first transition layer 304a ends with a first side 206 of the first transition layer 304a at which the first transition layer 304a is formed of the core material 108. The first transition layer 304a is deposited in-situ and the transition of material in the first transition layer 304a is achieved through in-situ deposition.

A layer of core material 108 is then deposited onto the first side 206 of the first transition layer 304a to result in the structure shown in a third stage 602c in FIG. 6. Since the first side 206 of the first transition layer 304a is composed of the core material 108, the core material 108 interfaces with a side of the first transition layer 304a which is composed of core material 108 thereby avoiding a sharp discontinuity in material composition (and refractive index) at a lower interface of the core material 108.

In some examples, two or more of the layer of cladding material 106, first transition layer 304a, and layer of core material 108 may be deposited in a single in-situ deposition.

The core material 108 is then subjected to a selective etching process to remove portions of the core material 108 to form a waveguide core as shown in a fourth stage 602d in FIG. 6. The selective etching process may correspond to the selective etching process described above with reference to FIG. 2. For example, a photoresist and photolithography process may be used to expose portions of the core material 108 which are then subjected to an etching process to form the waveguide core. In the example, shown in FIG. 6, portions of the core material 108 are etched down to the first transition layer 304a which is not etched. However, in other examples, portions of the first transition layer 304a may also be etched. Etching may be followed by a cleaning process. As an alternative to the selective etching process depicted in FIG. 6, the waveguide core may instead be formed through selective deposition.

A second transition layer 304b is then deposited onto the core material 108 and exposed portions of the first transition layer 304a resulting in the structure shown in a fifth stage 602e of FIG. 6. Whilst a different reference numeral 304b is used to denote the second transition layer 304b to the reference numeral used to denote a transition layer 204 in other Figures (in order to differentiate between a first 304a and second 304b transition layer in FIG. 6), the second transition layer 304b may share any of the features and/or methods of deposition as any other transition layer 204 described herein.

Deposition of the second transition layer 304b begins with a first side 206 of the second transition layer 304b at which the second transition layer 304b is formed of the core material 108.

Deposition of the second transition layer 304b ends with a second side 208 of the second transition layer 304b at which the second transition layer 304b is formed of the cladding material 106. The second transition layer 304b is deposited in-situ and the transition of material in the second transition layer 304b is achieved through in-situ deposition.

As is shown in the fifth stage 602e of FIG. 6, the second transition layer 304b is deposited on an upper surface of the core material 108, on side surfaces of the core material 108 and exposed portions of the first transition layer 304a. The first side 206 of the second transition layer 304b (which comprises core material 108) interfaces with the core material 108. Furthermore, parts of the second transition layer 304b are deposited on the first side 206 of the first transition layer 304a. That is, the first side 206 of the first transition layer 304a and the second side 208 of the second transition layer 304b (which are both formed of the core material 108) interface with each other. Similarly to the example of FIG. 4, the portions of transition layers 304a, 304b which extend laterally from the waveguide core serve to form a ridge waveguide shape.

After deposition of the second transition layer 304b, further cladding material 106 is deposited to encompass the core material 108 and a portion of the transition layers 304a, 304b as shown in a sixth stage 602f of FIG. 6. In some examples, the second transition layer 304b and cladding material 106 which is deposited on the second transition layer 304b may be deposited in a single in-situ deposition. The resulting waveguide structure as shown in the sixth stage 602f of FIG. 6 includes a transition of material at an upper interface between the waveguide core and the cladding material 106, at side surfaces of the waveguide core and at a lower interface between the waveguide core and the cladding material 106. All interfaces between the waveguide core and the cladding material 106 are therefore provided with a transition layer.

Several example waveguide structures and methods for their manufacture have been described above with reference to FIG. 1 to FIG. 6. It will be appreciated that there may be many further variations of structures are possible which incorporate at least one transition layer to provide a transition at one or more interfaces between a core material 108 and a cladding material 106. For example, similar principles and arrangements may be applied to any suitable waveguide shape such as a rib waveguide shape.

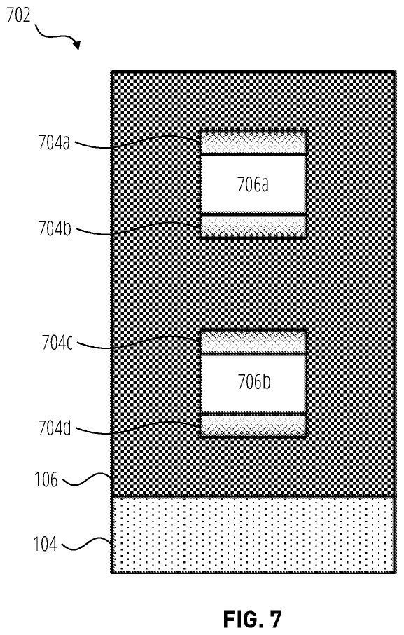

In some examples, one or more transition layers may be included in a multi-layer waveguide comprising a plurality of waveguide cores arranged in different layers. FIG. 7 is a schematic illustration of an example of a multi-layer waveguide 702 comprising a first waveguide core 706a and a second waveguide core 706b, where the first waveguide core 706a is fabricated on top of the second waveguide core 706b with a layer of cladding material 106 between the waveguide cores 706a, 706b.

In some examples, the thickness of the waveguide cores 706a, 706b may be greater than about 10 nanometres (nm). The thickness of the waveguide cores 706a, 706b may be less than about 400 nm. The layer of cladding material 106 situated between the waveguide cores 706a, 706b may be greater than about 50 nm. The layer of cladding material 106 situated between the waveguide cores 706a, 706b may be less than about 4000 nm.

In a multi-layer waveguide 702 arrangement a transition layer may be provided at any interfaces between either or both of the first waveguide core 706a and the second waveguide core 706b and the cladding material 106. It may however be particularly beneficial to include at least one transition layer between the waveguide cores. For example, a transition layer may be provide at an upper interface of a lower waveguide core (the second waveguide core 706b in FIG. 7) and/or a lower interface of an upper waveguide core (the first waveguide core 706a in FIG. 7). Such a transition layer may reduce photon transitions between different waveguide cores. Furthermore, in a multi-layer waveguide 702 structure an optical mode can exist in the region between the two waveguide cores 706a, 706b and one or more transition layers situated in between the waveguide cores may improve confinement of the optical mode.

In the example shown in FIG. 7 the first waveguide core 706a is provided with a first transition layer 704a at its upper interface and a second transition layer 704b at its lower interface. Similarly the second waveguide core 706b is provided with a third transition layer 704c at its upper interface and a fourth transition layer 704d at its lower interface.

In some examples, two or more of the layers of cladding material 106, transition layers 704a, 704b, 704c, and waveguide cores 706a, 706b may be deposited in a single in-situ deposition. For example, the entire stack of cladding material 106, transition layers 704a, 704b, 704c, and waveguide cores 706a, 706b shown in FIG. 7 could be deposited in a single in-situ deposition. The stack could then be subjected to a selective etching process to form the waveguide cores before deposition of further cladding material 106.

In some examples, a multi-layer waveguide 702 may include waveguide cores 706a, 706b formed of the same core material. However, in other examples, different waveguide cores 706a, 706b in a multi-layer waveguide 702 may be formed of different materials. For example, the first waveguide core 706a may comprise Si and the second waveguide core 706b may comprise Si₃N₄ or vice versa. The cladding material 106 may, for example, comprise SiO₂.

Examples have been described above in which a waveguide structure includes at least one transition layer to counteract effects of surface roughness at an interface between a cladding material 106 and a core material 108. However, in some examples, the effects of surface roughness may be reduced by depositing an additional thin film of core material after selective etching or selective deposition of a core material 108.

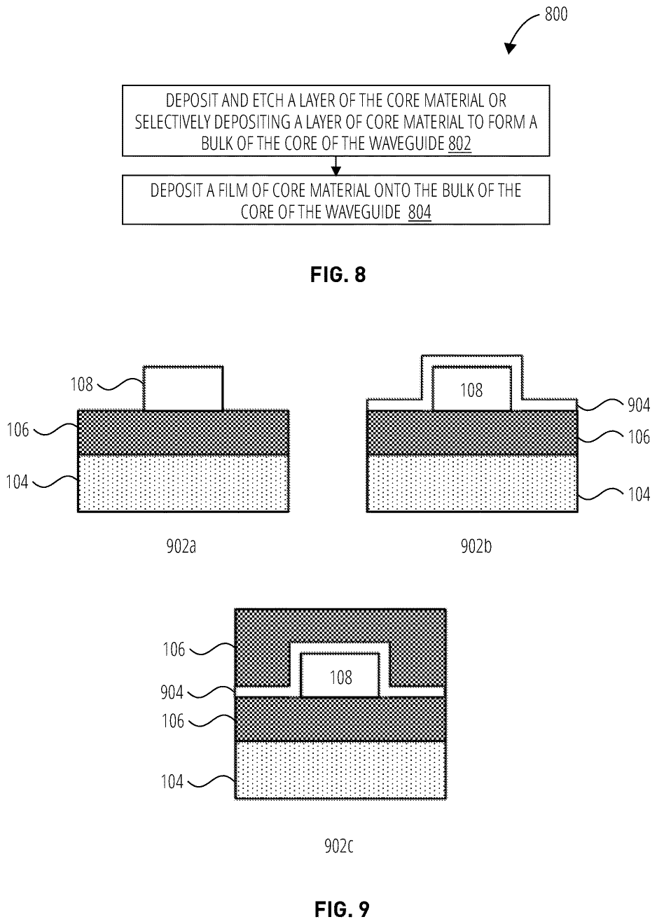

FIG. 8 is a flowchart of a method 800 of manufacture of a photonic waveguide according to some examples disclosed herein. FIG. 9 is a schematic illustration of cross-section of a waveguide manufactured according to the method 800 of FIG. 8.

At step 802 a layer of core material 108 is deposited and selectively etched or selectively deposited to form a bulk of the core of a waveguide. The result of this step is shown in a first stage 902a of FIG. 9. The core material 108 is deposited on a layer of cladding material 106 which is deposited on a substrate 104. Any of the features of selective etching or selective deposition which were described above may be used to form the waveguide core. For example, photolithography may be used to fabricate a mask in order to facilitate selective etching or selective deposition.

Selective etching or selective deposition of the waveguide core exposes side surfaces of the core which are formed through selective etching or selective deposition. As was explained above, such processes may be a significant source of surface roughness, for example, as a result of line edge roughness induced in photolithography.

At step 804, a film of core material 904 is deposited onto the bulk of the core of the waveguide. The result of step 804 is shown in a second stage 902b in FIG. 9. The film of core material 904 may be a thin film and may serve to reduce a surface roughness of at least side surfaces of the waveguide core. For example, the thin film of core material 904 may serve to fill in indentations in surfaces of the waveguide core which resulted from the selective etching or deposition, thereby smoothing the surfaces.

A further layer of cladding material 106 may then be deposited to encompass the core material 108 as shown in a third stage 902c in FIG. 9. Due to the addition of the thin film of core material 904, the surface roughness at an interface between the core material 108 and the cladding material 106 may be reduced which may serve to reduce photon scattering at the interface and associated optical loss.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. In particular, any dependent claims may be combined with any of the independent claims and any of the other dependent claims.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of manufacture of a photonic waveguide, the waveguide comprising a core material and a cladding material, the method comprising:
depositing a transition layer, wherein a material from which the transition layer is formed transitions as a function of distance between a first side of the transition layer, at which the transition layer is formed of the core material, and a second side of the transition layer, at which the transition layer is formed of the cladding material.

2. The method of claim 1, wherein depositing the transition layer comprises releasing a plurality of different source materials, wherein the source materials are deposited to form the deposited transition layer, and wherein a rate at which at least one of the source materials is released during the deposition of the transition layer is varied with time during the deposition so that the material composition of the transition layer being deposited varies as a function of time during the deposition.

3. The method of claim 1, wherein the method further comprises depositing a further transition layer, wherein a material from which the further transition layer is formed transitions as a function of distance between a first side of the further transition layer, at which the transition layer is formed of the core material, and a second side of the further transition layer, at which the further transition layer is formed of the cladding material.

4. The method of claim 1, wherein the method comprises depositing a layer of core material to form a bulk of the core of the waveguide.

5. (canceled)

6. The method of claim 4, wherein the method comprises etching or selectively depositing the layer of core material to form at least one side surface of the bulk of the core of the waveguide,
wherein the transition layer is deposited after etching or selectively depositing the layer of core material such that the transition layer is deposited onto the at least side surface of the bulk of the core of the waveguide.

7. The method of claim 6, wherein the layer of core material is deposited and etched or selectively deposited to form the bulk of the core of the waveguide on a base layer of core material having a width greater than the bulk of the core of the waveguide so as to form a ridge waveguide core, and
wherein the transition layer is deposited onto the ridge waveguide core.

8. (canceled)

9. (canceled)

10. (canceled)

11. The method of claim 1, wherein the photonic waveguide comprises a multi-layer waveguide comprising a plurality of waveguide cores fabricated on top of each other with a layer of waveguide cladding in between the waveguide cores.

12. The method of claim 11, wherein the transition layer is deposited in between at least a first waveguide core of the multi-layer waveguide and a second waveguide core of the multi-layer waveguide core.

13. The method of claim 12, wherein the first waveguide core of the multi-layer waveguide has a different core material to the second waveguide core of the multi-layer waveguide.

14. (canceled)

15. The method of claim 13, wherein the transition layer providing a transition between the core material of the first waveguide core and the cladding comprises a first transition layer and the method comprises depositing a second transition layer, the second transition layer providing a transition between the core material of the second waveguide core and a cladding material.

16. A method of manufacture of a photonic waveguide, the waveguide comprising a core material and a cladding material, the method comprising:
depositing and etching a layer of the core material or selectively depositing a layer of core material to form a bulk of the core of the waveguide; and
depositing a film of core material onto the bulk of the core of the waveguide.

17. (canceled)

18. (canceled)

19. A photonic waveguide, the waveguide comprising:
a core material;
a cladding material arranged to encompass a portion of the core material; and
a transition layer situated between at least a portion of the core material and the cladding material, wherein a material from which the transition layer is formed, transitions as a function of distance between a first side of the transition layer in contact with the core material and at which the transition layer is formed of the core material and a second side of the transition layer in contact with the cladding material and at which the transition layer is formed of the cladding material.

20. The waveguide of claim 19, wherein the waveguide comprises a waveguide core formed of the core material and the transition layer is arranged to provide a material transition between a lower surface of the waveguide core and the cladding material.

21. The waveguide of claim 19, wherein the waveguide comprises a waveguide core formed of the core material and the transition layer is arranged to provide a material transition between an upper surface of the waveguide core and the cladding material.

22. The waveguide of claim 19, wherein the waveguide comprises a waveguide core formed of the core material and the transition layer is arranged to provide a material transition between at least one side surface of the waveguide core and the cladding material.

23. The waveguide of claim 19, comprising a further transition layer situated between at least a portion of the core material and at least a portion of the cladding material, wherein a material from which the further transition layer is formed transitions as a function of distance between a first side of the further transition layer, at which the transition layer is formed of the core material, and a second side of the further transition layer, at which the further transition layer is formed of the cladding material.

24. The waveguide of claim 19, wherein the photonic waveguide comprises a multi-layer waveguide comprising a plurality of waveguide cores fabricated on top of each other with a layer of waveguide cladding in between the waveguide cores.

25. The waveguide of claim 24, wherein the transition layer is situated in between at least a first waveguide core of the multi-layer waveguide and a second waveguide core of the multi-layer waveguide.

26. The waveguide of claim 25, wherein the first waveguide core of the multi-layer waveguide has a different core material to the second waveguide core of the multi-layer waveguide.

27. The waveguide of claim 26, wherein the transition layer provides a transition between the core material of the first waveguide core and a cladding material situated between the first waveguide core and the second waveguide core.

28. (canceled)
